(19) United States
(12) Patent Application Publication
(10) Pub. No.: US 2010/0309905 A1
(43) Pub. Date: Dec. 9, 2010

(54) NETWORK PHONE

(75) Inventors: Cheng-Hsiung Lu, Xinzhuang City (TW); Ching-Feng Hsieh, Taipei (TW)

Correspondence Address: EDWARDS ANGELL PALMER & DODGE LLP, P.O. BOX 55874, BOSTON, MA, 02205, US

(73) Assignee: ASKEY COMPUTER CORPORATION, Taipei (TW)

(21) Appl. No.: 12/559,639

(22) Filed: Sep. 15, 2009

(30) Foreign Application Priority Data
Jun. 8, 2009 (TW) 098119004

(51) Int. Cl. H04L 12/66

(52) U.S. Cl. 370/352

(57) ABSTRACT

A network phone includes a base unit, a handset unit and a coiled wire cord connecting the handset unit and the base unit. The base unit is connected to at least one network line for receiving a first digital communication signal or transmitting a second digital communication signal via the network line, and further combining the power of the handset unit with the first digital communication signal so as to form an integrated communication signal. The handset unit decomposes the integrated communication signal back into power and the first digital communication signal. The coiled wire cord is adapted to transmit the integrated communication signal from the base unit to the handset unit, or to transmit the second digital communication signal from the handset unit to the base unit, thereby providing a net-phone device with signal conversion functionality with a coiled wire cord.

### BACKGROUND OF THE INVENTION

1. Field of the Invention

This invention relates to network phones, and more particularly, to a network phone that transmits a digital communication signal and the power obtained from a handset unit via a coiled wire cord.

2. Description of Related Art

Recently, network phones are becoming popular because more and more people use a network and the cost of using the network to communicate with others is low compared to the conventional telephone network (POTS). As such, a variety of network phones have come to the market, including a network phone having a USB interface, a network phone that connects a network line to a handset, and a network phone that connects a network line to a station.

A network phone transmits a digital communication signal via an Ethernet cable, for example, and converts the digital communication signal into an analog audio signal, so as to realize the functions of a phone. The network phone that has the USB interface needs to work in conjunction with a computer. Accordingly, the network phone is necessarily tethered to the location of the computer. Moreover, for a network phone that connects a network line to a handset unit, a user, when making a phone call, is restricted by the length of the network line, since the network line has little elasticity to allow it to extend and retract. Further, the handset unit, since being connected to the network line directly, often has an unpleasant or non-conventional appearance. Lastly, for a network phone that connects a network line to a base unit, a user has to manipulate the base unit to dial or access other functions because the base unit comprises a variety of components, such as a keyboard and a processor, which results in inconvenient usage and limitations in terms of placement.

TW Patent No. 574812 discloses a dual purpose (analog and IP) intelligent handset, which is applicable to a handset having both analog and VOIP functions. The handset has an RJ-11 port connectible to a conventional phone line, and an RJ-45 Ethernet port connectable to a broadband network such as ADSL. A user uses the intelligent handset, according to his needs, to make a variety of phone calls, such as conventional phone calls, VOIP phone calls, and automatically switched phone calls, so as to save on calling changes, particularly long distance ones, without sacrificing voice quality. However, the intelligent handset features an “automatically switched function.” In such a dialing function mode, the handset is used to make phone calls, communicate with other parties and provide fast and convenient phone paging functions like a conventional phone. However, a user has to dial or access settings via a station when making a call, which is inconvenient in operation for the user.

As such, developing a way to provide a handset unit that can transmit a network signal via a coiled wire cord and allow a user to dial and access settings with the handset as with a traditional handset is quite desirable.

### SUMMARY OF THE INVENTION

In view of the above-mentioned problems of the prior art, the present invention provides a network phone providing network phone functionality that retains the use of a conventional coiled wire cord without significantly altering the appearance of the handset, such that the network phone can be applied to a variety of application environments.

The present invention provides a network phone that includes a base unit connected to a network line for receiving a first digital communication signal and/or transmitting a second digital communication signal via the network line, and acquiring network line power transmitted over the network line, the base unit having a signal bridging unit for amplifying the first digital communication signal, a power converting unit for capturing network line power from the network line and converting the network line power into handset unit power, and a combining unit for combining the handset unit power with the first digital communication signal amplified by the signal bridging unit so as to form an integrated communication signal and for connecting the signal bridging unit to the power converting unit; a handset unit for restoring the integrated communication signal into the handset unit power and the amplified first digital communication signal, using the handset unit power to convert the amplified first digital communication signal into a first voice signal, and/or to convert a second voice signal received from outside into the second digital communication signal; and a coiled wire cord connecting the base unit and the handset unit for transmitting the integrated communication signal from the base unit to the handset unit and/or transmitting the second digital communication signal from the handset unit to the base unit.

In an embodiment of the present invention, the base unit and the handset unit are connected to each other via an RJ22 interface; the signal bridging unit is formed with a first route, a second route, a third route and a fourth route, the first route and the second route acting as a signal transmission route (Tx), and the third route and the fourth route acting as a signal reception route (Rx); and the combining unit has a center-tapped structure, for feeding the handset unit power to the first route, the second route, the third route and the fourth route formed by the signal bridging unit, so as to form the integrated communication signal, allowing the first route, the second route, the third route and the fourth route to transmit the integrated communication signal via the coiled wire cord to the handset unit.

In another embodiment of the present invention, the handset unit further includes: a power capturing unit for capturing the handset unit power from the integrated communication signal and supplying the handset unit with the handset unit power; a keyboard unit for receiving a key input signal; a voice input unit for receiving the second voice signal; a voice output unit for outputting the first voice signal; and a processing unit connected to the keyboard unit, the voice input unit and the voice output unit for capturing the first digital communication signal from the integrated communication signal transmitted over coiled wire cord, converting the first digital communication signal into the first voice signal and outputting the first voice signal via the voice output unit, and/or converting the key input signal from the keyboard unit and/or the second voice signal from the voice input unit into the second digital communication signal and transmitting the second digital communication signal via the coiled wire cord to the base unit.

Compared to the prior art, the network phone according to the present invention provides a base unit with a power converting unit and a signal bridging unit to combine a network signal into an integrated communication signal having a digital communication signal and handset unit power; transmits the integrated communication signal via a coiled wire cord; captures the handset unit power from the integrated communication signal via a power capturing unit; supplies the handset unit with the handset unit power; and converts the digital communication signal into a voice signal. In that the coiled wire cord according to the present invention carries handset unit power and the integrated communication signal of the digital communication signal, a variety of components, such as keys and processor, can be installed in the handset unit, allowing the handset unit to perform conversion between an analog signal and a digital signal. Therefore, the base unit has a simplified design, and a user can make a phone call conveniently.

### BRIEF DESCRIPTION OF DRAWINGS

FIG. 1 is a functional block diagram of a network phone according to the present invention; and

FIG. 2 is a schematic diagram illustrating an embodiment of the network phone according to the present invention.

### DETAILED DESCRIPTION OF PREFERRED EMBODIMENTS

The following illustrative embodiments are provided to illustrate the disclosure of the present invention; these and other advantages and effects can be readily understood by those in the art upon reading this disclosure. The present invention can also be performed or applied by differing embodiments. The details of the specification may be changed on the basis of different points and applications, and numerous modifications and variations can be devised without departing from the spirit of the present invention.

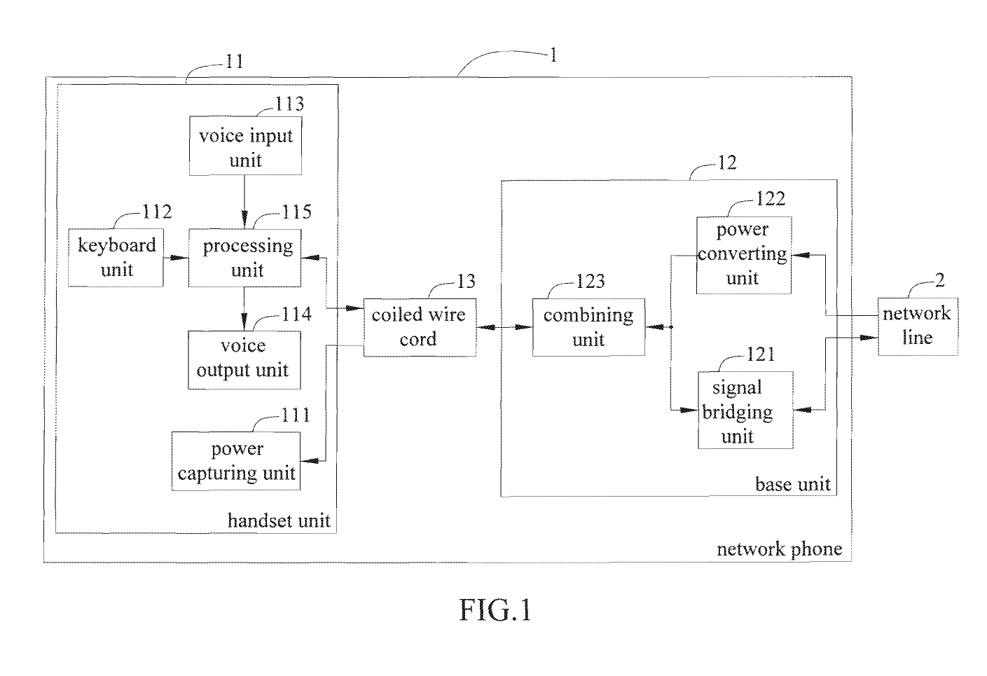

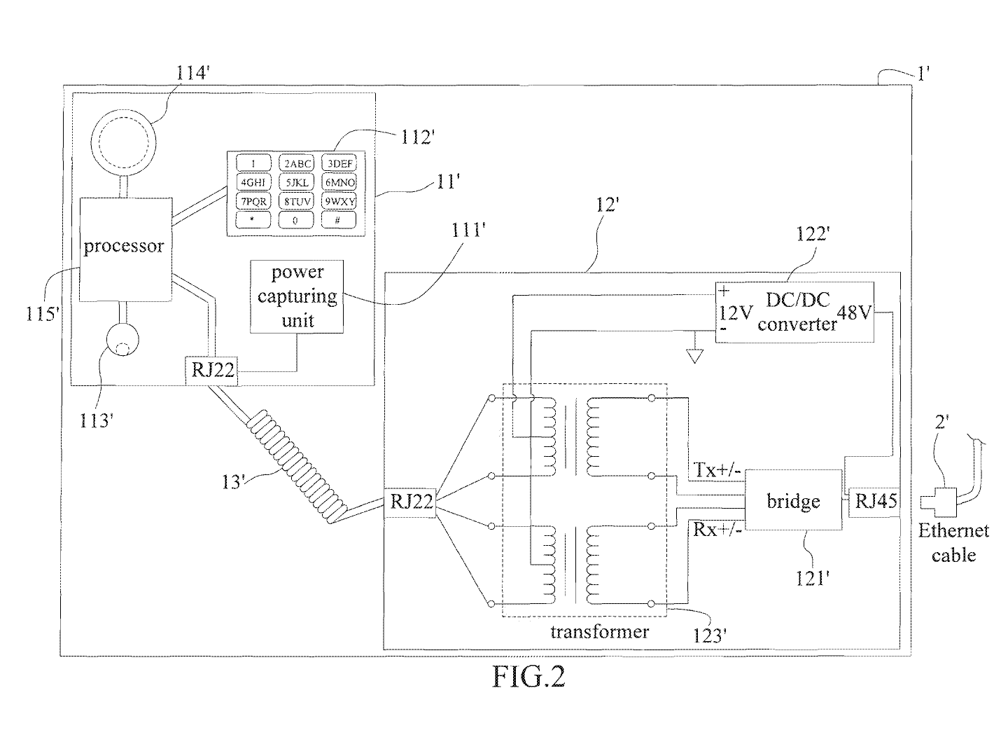

FIG. 1 is a functional block diagram of a network phone 1 according to the present invention. The network phone 1 comprises a handset unit 11, a base unit 12, and a coiled wire cord 13 connected to the handset unit 11 and the base unit 12. In an embodiment of the present invention, RJ22 interfaces are connected between the handset unit 11 and the coiled wire cord 13, and between the base unit 12 and the coiled wire cord 13. The above-disclosed components are described in detail in accordance with FIGS. 1 and 2 as follows.

The handset unit 11 comprises a power capturing unit 111, a keyboard unit 112, a voice input unit 113, a voice output unit 114, and a processing unit 115 connected to the keyboard unit 112, the voice input unit 113 and the voice output unit 114.

In an embodiment of the present invention, the power capturing unit 111 captures handset unit power from an integrated communication signal (that will be described in the following paragraphs) transmitted over the coiled wire cord 13, and supplies the handset unit 11 with the handset unit power. The handset unit power is limited by the wire gauge diameter and composition of the coiled wire cord 13 and the voltage that the coiled wire cord 13 can handle safely. Preferably, the handset unit power has a voltage level less than 30 volts, e.g., 12 volts.

The keyboard unit 112 provides a key input operation to generate and output a key input signal. As shown in FIG. 2, the keyboard unit 112 can be realized by a keypad 112′.

The voice input unit 113 provides a voice inputting function to generate and input a second voice signal (i.e., an analog signal generated by a user of the handset unit upon speaking). For example, the voice input unit 113 can be realized by a microphone 113′ shown in FIG. 3, allowing a user to input the second voice signal during a call.

The voice output unit 114 receives the first voice signal (i.e., an analog signal converted by the processing unit 115 from a signal transmitted via the network line) output by the processing unit 115. For example, as shown in FIG. 2, the voice output unit 114 can be realized by a receiver 114′ or a speaker.

The processing unit 115 captures a first communication signal (i.e., a signal transmitted from the network line) from the integrated communication signal transmitted from the coiled wire cord 13, converts the first communication signal into the first voice signal, and outputs the first voice signal via the voice output unit 114. Additionally, the processing unit 115 further receives the key input signal output by the keyboard unit 112 and/or the second voice signal output by the voice input unit 113, converts the key input signal and/or the second voice signal into a second digital communication signal (i.e., a digital signal transmitted to a remote user via a network line), and transmits the second digital communication signal to the base unit via the coiled wire cord 13. As shown in FIG. 3, the processing unit 115 can be realized by a processor 115′.

The base unit 12 is connected to at least one network line 2, for receiving a network signal via the network line 2 and converting the network signal into an integrated communication signal. The network line 2 and the base unit 12 are connected via an RJ45 interface. In an embodiment of the present invention, the network line 2 is an Ethernet cable. Further, the base unit 12 consists of a signal bridging unit 121, a power converting unit 122, and a combining unit 123 connected to the power converting unit 122 and the signal bridging unit 121.

The signal bridging unit 121 captures the first digital communication signal from the network signal, and amplifies the first digital communication signal. In an embodiment of the present invention, the signal bridging unit 121 is a bridge, a converter, a hub or a signal relay apparatus. As shown in FIG. 2, the signal bridging unit 121 is realized by a bridge 121′, and the signal bridging unit 121 is formed to have a first route, a second route, a third route and a fourth route. In an embodiment of the present invention, the first and second routes act as a signal transmission route (Tx), while the third and fourth routes act as a signal reception route (Rx). In another embodiment of the present invention, the first and second routes act as the signal reception route (Rx), while the third and fourth routes act as the signal transmission route (Tx).

The power converting unit 122 captures network line power from the network signal, and converts the network line power into handset unit power. In an embodiment of the present invention, the network line power has a voltage level equal to 48 volts, and the power converting unit 122 is a DC/DC converter 122′, as shown in FIG. 2.

The combining unit 123 combines said handset unit power from the power converting unit 122 with the first digital communication signal from the signal bridging unit 121 to form the integrated communication signal, and transmits the integrated communication signal via the coiled wire cord 13 to the handset unit 11. In an embodiment of the present invention, the combining unit 122 employees a transformer with a center-tapped structure, for feeding the handset unit power into the first route, the second route, the third route and the fourth route formed by the signal bridging unit 121 so as to form the integrated communication signal, allowing the first route, the second route, the third route and the fourth route to transmit the integrated communication signal to the coiled wire cord 13. Accordingly, the coiled wire cord 13 has a first conductor connected to the first route, a second conductor connected to the second route, a third conductor connected to the third route, and a fourth conductor connected to the fourth route. The first conductor is wound with the second conductor, and the third conductor is wound with the fourth conductor. The combining unit 123 further receives a second digital communication signal from the coiled wire cord 13, and outputs the second digital communication signal to the signal bridging unit 121, allowing the second digital communication signal to be amplified by the signal bridging unit 121 and output by the network line 2. Therefore, a calling party in a network communication system can receive the second digital communication signal. In an embodiment of the present invention, the combining unit 123 is realized by a center-tapped transformer 123′, as shown in FIG. 2.

In order to understand how a network phone according to the present invention realizes the network phone function clearly, an example wherein a calling party and a receiving party conduct a call is described as follows, in accordance with FIG. 2. When the receiving party receives via the RJ45 interface a network signal transmitted over the Ethernet cable 2′ by the calling party, the bridge 121′ captures the first communication signal from the network signal, and amplifies the first digital communication signal. At the same time, the DC/DC converter 122′ captures network line power from the network signal, and converts the network line power into handset unit power. Then, the transformer 123′ combines the handset unit power with the first digital communication signal to form the integrated communication signal. The integrated communication signal is transmitted by the base unit 12′ via the RJ22 interface to the coiled wire cord (curly cord) 13′, and transmitted via the RJ22 interface between the handset unit 11′ and the coiled wire cord 13′ to the handset unit 11′, such that the power capturer 111′ captures the handset unit power from the integrated communication signal and supplies the handset unit 11′ with the handset unit power. The processing unit 115′ captures the first digital communication signal from the integrated communication signal, converts the integrated communication signal into the first voice signal, and outputs the first voice signal via the receiver 114′. At the same time, the receiving party can hear the first voice signal output by the receiver 114′. The above procedure illustrates the receiving mode of the handset unit.

When the receiving party performs a key input operation with a keypad 112′ on the handset unit 11′ to generate and output a key input signal, or emits an analog signal into the microphone 113′ to allow the microphone 113′ to receive a second voice signal, the processor 115′ converts the key input signal or the second voice signal into the second digital communication signal, and outputs the second digital communication signal via the RJ22 interface of the coiled wire cord 13′ connected between the handset unit 11′ and the base unit 12′ to be received by the base unit 12′, allowing the bridge 121′ installed in the base unit 12 to amplify the second digital communication signal and output the amplified second digital communication signal via the RJ45 interface between the base unit 12′ and the Ethernet cable 2′ onto the Ethernet cable 2′. Therefore, the calling party in the network communication system can receive the second digital communication signal. The above procedure illustrates the transmitting mode of the handset unit.

Note that in the above embodiment it is exemplified that the key input signal generated by the keyboard unit or the second voice signal received by the microphone 113′ is converted into the second digital communication signal and transmitted to the calling party; however, this is not intended to limit the present invention. In another embodiment of the present invention, other kinds of signals can be converted into the second digital communication signal and transmitted to the calling party. The transmission way of the other kinds of signals is the same as those described in the above-mentioned embodiments, so further description is omitted.

A network phone according to the present invention receives a network signal with a network line at a base unit end, captures a first digital communication signal from the network signal via a signal bridging unit, amplifies the first digital communication signal, captures network line power from the network signal via a power converting unit, converts the network line power into handset unit power, combines said handset unit power with the first digital communication signal via a combining unit to form an integrated communication signal, transmits the integrated communication signal via a coiled wire cord to a handset unit, decomposes at the handset unit end the integrated communication signal into a first voice signal and the handset unit power, supplies the handset unit power to the handset unit, and outputs the first voice signal via a voice output unit. In this way, network phone communication efficacy is provided without sacrificing the convenience, functionality and aesthetics provided by a conventional coiled wire cord, and the network phone can be applied to a variety of application environments.

The network phone according to the present invention has various advantages, summarized as follows:

(1) User friendliness—since, in the present invention, the digital communication signal and power are transmitted over the coiled wire cord and are converted by the handset unit, a user, when making a phone call, will not be unduly limited by the location of the place where the base unit is placed.

(2) Simplified design—since, in the present invention, a coiled wire cord is employed to transmit the network signals, and both the processor and the keys are installed in the handset unit, the base unit thus has a simplified design and still employs the coiled wire cord of a conventional handset unit. Therefore, the network phone of the present invention is functionally convenient and has an aesthetically pleasing design.

The foregoing descriptions of the detailed embodiments are provided to disclose the features and functions of the present invention and not intended to be restrictive of the scope of the present invention. It should be understood by those in the art that various modifications and variations can be effected according to the spirit and principles in the disclosure of the present invention and still fall within the scope of the appended claims.
1 network phone
11 handset unit
111 power capturing unit
112 keyboard unit
113 voice input unit
114 voice output unit
115 processing unit
12 base unit
121 signal bridging unit
122 power converting unit
123 combining unit
13 coiled wire cord
2 network line
1′ network phone
11′ handset unit
111′ power capturing unit
112′ keyboard
113′ microphone
114′ receiver
115′ processor
12′ base unit
121′ bridge
122′ DC/DC converter
123′ transformer
13′ coiled wire cord
2′ Ethernet cable

What is claimed is:

1. A network phone, comprising:
a base unit connected to a network line for receiving a first digital communication signal or transmitting a second digital communication signal via the network line, and acquiring network line power transmitted over the network line, the base unit having a signal bridging unit for amplifying the first digital communication signal, a power converting unit for capturing the network line power from the network line and converting the network line power into handset unit power, and a combining unit for combining the handset unit power with the first digital communication signal amplified by the signal bridging unit so as to form an integrated communication signal and for connecting the signal bridging unit to the power converting unit;
a handset unit for decomposing the integrated communication signal into the handset unit power and the amplified first digital communication signal, using the handset unit power to convert the amplified first digital communication signal into a first voice signal, and/or to convert a second voice signal received from the environment into the second digital communication signal; and
a coiled wire cord connected to the base unit and the handset unit for transmitting the integrated communication signal from the base unit to the handset unit or transmitting the second digital communication signal from the handset unit to the base unit.

2. The network phone of claim 1, wherein the base unit and the handset unit are connected to the coiled wire cord via an RJ22 interface.

3. The network phone of claim 1, wherein the handset unit power has a voltage level less than 30 volts.

4. The network phone of claim 1, wherein the signal bridging unit has a first route, a second route, a third route and a fourth route, the first and second routes acting as a signal transmission route (Tx), the third and fourth routes acting as a signal reception route (Rx).

5. The network phone of claim 4, wherein the combining unit has a center-tapped structure that feeds the handset unit power to the first route, the second route, the third route and the fourth route formed by the signal bridging unit, so as to form the integrated communication signal, allowing the first route, the second route, the third route and the fourth route to transmit the integrated communication signal to the coiled wire cord via the base unit.

6. The network phone of claim 1, wherein the handset unit comprises:
a power capturing unit for capturing the handset unit power from the integrated communication signal and supplying the handset unit with the handset unit power;
a keyboard unit for receiving a key input signal;
a voice input unit for receiving the second voice signal;
a voice output unit for outputting the first voice signal; and
a processing unit connected to the keyboard unit, the voice input unit and the voice output unit for capturing the first digital communication signal from the integrated communication signal transmitted over the coiled wire cord, converting the first digital communication signal into the first voice signal and outputting the first voice signal via the voice output unit, and/or converting the key input signal from the keyboard unit and/or the second voice signal from the voice input unit into the second digital communication signal and transmitting the second digital communication signal via the coiled wire cord to the base unit.

7. The network phone of claim 1, wherein the network line and the base unit are connected via an RJ45 interface.

8. The network phone of claim 7, wherein the network line is an Ethernet cable.

9. The network phone of claim 6, wherein the voice input unit is a microphone.

10. The network phone of claim 6, wherein the voice output unit is a receiver or a speaker.

11. The network phone of claim 1, wherein the power converting unit is a DC/DC converter.

12. The network phone of claim 1, wherein the signal bridging unit is a bridge, a converter, a hub or a signal relay apparatus.

13. The network phone of claim 1, wherein the combining unit is a transformer.
